(19) United States
(12) Patent Application Publication
(10) Pub. No.: US 2016/0238491 A1
(43) Pub. Date: Aug. 18, 2016

(54) SYSTEM FOR TAKING SAMPLES OF LIQUID SLAG, MOLTEN METALS OR SIMILAR

(71) Applicant: CHESTA INGENIERÍA S.A., Ñuñoa, Santiago, C.P. (CL)

(72) Inventor: Alberto Antonio SUPELVED MUÑOZ, Macul Santiago (CL)

(21) Appl. No.: 14/781,934

(22) PCT Filed: Nov. 5, 2013
(86) PCT No.: PCT/CL2013/000081

§ 371 Date: Oct. 2, 2015

(51) Int. Cl. G01N 1/14

(52) U.S. Cl. CPC G01N 1/1409

(57) ABSTRACT

System for taking samples of liquid slag, molten metals or similar, to analyze the quality and content of a mineral, partially deriving from the processes used to obtain minerals. This system allows to improve working conditions and the quality of life of operators and to obtain proper-sized samples and without risk, characterized because the system for the sampling of liquid slag is made up of a remote electronic mobile handling device (I). Equipped with a spoon-type probe (2), as a means to collect dangerous samples from a distance such as liquid slag or molten metals. It also has a base grill (3), as a platform for all areas of the sampling system; a support structure (4) for a rail (5) and a D bin for liquid samples of slag or molten metal (6), and a support and platform (7) for a can or bin to mix water and lime (8).

### FIELD OF THE INVENTION

The invention refers to a system for the taking of samples (on demand) of liquid slag molten metal or similar, to analyze the quality and content of a mineral deriving partly from the processes used to obtain minerals. This system is made up of mobile remote means, used for handling when taking samples (on demand) of slag or molten metals adjustable and removable structural means, which facilitate the working area in handling and moving said sampling of slag or molten metals, the main object of which in the sampling process is to avoid operational risks that exist in the manual systems currently used when melting metals or minerals.

With regards to the state of the art, in the system or devices for the sampling of liquid slag or molten metal or similar, we can cite patent ES 526,122 which refers to a sampling device for molten metal which consists of a tube and in a fixed head at the end of it, where the sample is housed, where the head holds a body of refractory material that partially limits the sampling chamber. It is equipped with an opening into the sampling chamber and which joined to the tube mentioned in such way that the sampling chamber remains located completely outside the tube, providing the use of at least one small cooling plate that makes up at least one part of the sampling chamber wall and, therefore also limits this sampling chamber.

Another patent that refers to probes in the US D on sampling molten metal is patent ES 2315978 which refers to an immersion proble that has a probe body that has a longitudinal axis and an outside surface around the longitudinal axis, showing part of the outer surface, elements of sample taking that have a radial dimension and extend circumferentially around the axis characterized because the sample taking elements (4) show a flat or concave surface opposing the immersion end of the probe body inclined according to the longitudinal axis in the direction of the end of the probe body (I) opposed to the immersion end and because the sampling elements (4) are configured as one or more annular elements consecutively provided in the direction of the longitudinal axis.

Another sampling device for sampling devices for the thermal analysis in metal solidification is mentioned in patent application CL No 01 30-19 96 which consists of a container (20) used to contain a certain amount of samples (30) of liquid metal during its analysis, and at least one sensor (40) for thermal analysis, with said sensor(s) to be used to be submerged in the amount of sample metal in solidification during its analysis. The container is made up of an internal wall (50), with an internal surface (60) intended to handle the sample quantity during the analysis and an outer surface (70); an outer wall (80), with an outer surface (100) intended to handle the atmospheric environment and an inner surface (90). Said walls are joined at the mouth of the container, where the outer surface of the inner wall and the inner surface of the outer wall jointly define an essentially closed space. The sampling device is intended to be used to quickly conduct the measurements of the thermal analysis upon the solidification of cast iron.

Currently metal or mineral casting and specifically for minerals, there are concentrates processes, in stages that can be summarized as follows:

The material deriving from the Load Preparation Unit are processed in fluid bed dryers until a moisture content of 0.2% achieved.

The dry concentrate obtained is injected with oxygen-enriched air jets to the converters to stimulate the oxidation of the impurities in a continuous reaction which is sustained by its own heat. This process is called Fusion and Conversion.

While the concentrate becomes a melted liquid mass, its components separate and recombining they form a two-layer bath. The heavier layer is called White Metal (containing 75% copper, at 1220° C.) and the lighter layer is Slag (which has 8% to 10% copper, at 1240° C.).

Slag resulting from the converter is moved to slag cleaning furnaces (Electric Oven), from which white metal is obtained with 71% copper to return to the Pierce Smith converters.

The slag from the Cleaning Oven, with a content below 0.8% copper is moved by freight train to the dump.

White metal consists of sulphurs and is made up mostly of copper and a small percentage of iron and is sent to the Piece Smith Converters, where compressed air is blown.

In the resulting reaction, most sulphurs and irons rust, generating blister copper, with 97% purity and 98% of metallic copper.

Blister copper is processed in Tilting Furnaces producing anodes with 33.6% of fire refined copper.

The last stage consists of Electrolytic Refine where anode mud is obtained which is sent to the Noble Metals Plant (gold, silver) and cathodes with 33.33% copper.

A relevant aspect of the production process is the slag sampling operation for quality and copper content analysis in the slag, this percentage determines the quality and performance of the production process, therefore allowing to improve and optimize material end power resources and minimize the loss of metals due to errors in the Production process.

Operationally, the stages that make up the current process are as follows:

The operator that takes the sample must wear aluminized protective clothing from head to toe.

The operator enters the enclosure where the sampling is performed.

The operator takes the pallet and bathes it in a lime solution to avoid the slag from adhering.

The same is done with the metallic repository for sample storage, better known as “bin”.

The operator is located near an opening of the sampling splash protection located at the end of the channel through which the slag falls in the pots.

When the slag is falling into the pot the operator inserts the pallet in the slag through the opening, rotates the pallet and extracts the sample.

The operator then turns the incandescent simple over the “bin”

This process is performed routinely in shifts of 4×4 during 24 hours per day. This procedure is performed in each shift between three and four times and has a duration of approximately 30 minutes.

During this process room temperature rises to 40 or 50° C.

Then, after the sample has solidified, part of the sample is taken to the laboratory for analysis.

Generally, sampling can be done cold and all of the delays and additional processes required or in can be done hot.

In the latter, the most freq cent way is to use a disposable Sand Probe or a Borosilicate vacuum tube.

### a) Disposable Sand Probe (SAF)

Currently in the market there is a disposable immersion sampler (SAF). It consists of a small probe with a sand body and an internal chamber where the simple is stored. The dimensions of the largest sample that can be obtained with these probes are 35 mm in diameter by 24 mm height, which generates a sample in the shape of a medal.

There is a steel tube coupled to the sand body on its lower end with which the sand body is submerged inside the melted material. To protect the steel tube from high temperatures it is covered with a cardboard tube that is GOOmm long, which supports temperatures up to 1,800° C. for a few seconds (each cardboard tube is included in the sampling kit).

To obtain a sample using the SAF probe, the sand body must be submerged in the melted metal using the tube for a period of 3 to 4 seconds maximum, so that the internal chamber of the probe can be filled. After removing the probe from the melted material it has to be left to cool until the material inside has solidified. Then the sand body must be broken (a simple hit or impact against the ground)

It must be considered that the size of the largest available sample has a diameter of 35 mm and a height of 24 mm. The approximate density of the slag corresponds to the order of 2 g/cm3. Taking into account that a sample must be obtained of at least the same quantity as was obtained in the previous process (400 g in this case there are samples obtained with an approximate weight of 4G·I8 g per ample, to obtain the 400 g needed for the sample per pot, we would need 9 probes. When considering that each train has 7 pots, we should think of a total of G3 probes per train, and if we consider approximately 14 trains full per day it adds up to a total of 882 daily probes, which in no doubt makes it more costly and makes total efficiency difficult.

### b) Borosilicate Vacuum Tube

Borosilicate vacuum tubes have been in the market since the 1960s, also known as “Vacuum Pin Tubes” or “Evacuated Pin Tubes”. These small tubes that are manufactured in borosilicate, more commonly, known as pyrex glass are widely used in the sampling of melted steel, gold and silver for the analysis of hydrogen. The use of borosilicate glass gives great resistance from damaging substances.

The tube is sealed on both ends with a bulb of thin walls at one side (weak point) which breaks upon making contact with the melted metal. The melted metal enters the tube to form a free solid sample. To obtain a sample with borosilicate vacuum tubes the tube must be held with tongs, common for these samplers. The layer of slag must be separated and the tube is to be inserted in the melted metal at a 45° angle (approximately) until the “bulb” section (weak point) is completely submerged. This will break the weak point of the tube and will fill it with molten metal. Upon removing it from the molten metal it must left to cool until the metal inside the tube solidifies. The tube must then be broken (a simple hit or impact against the ground), which results inf a solid nail-shaped sample.

Such as is the case with sand samplers, borosilicate vacuum tubes are designed for the sampling of high purity metals not for slag. As a consequence the results of attempting to sample slag directly are unknown.

It must be considered that the largest sample size available will have a diameter of Bmm and a height of 140 mm which repeats the problem above.

The main objectives of the invention are:

[symbol]

Then, the technical problems that must be solved by the removable sampling system can be summarized as follows:

a) Remove operators from the line of fire distancing them from risks associated with the operation as is done today and limiting maintenance interactions.

b) Improve working conditions and quality of life of the operators

c) Obtain proper sized samples

d) Standardize the operation.

e) Improve the management of production, providing more traceability and optimization possibilities.

f) Marketing possibilities and applying to other equipment and industries.

### BRIEF DESCRIPTION OF FIGURES

To better understand the essential characteristics of the invention, for a system for sampling liquid slag or molten metal or similar, it will be described according to the figures that form an integral part of the invention, without it meaning to restrict obvious modifications that may arise, where:

FIG. 1 shows a general perspective view of the means that make up the slag or melted mineral sampling system of the invention and the installation area of the low area of the Channels, close to the opening towards the pots of the trains.

FIG. 2 shows a perspective view of the mobile remote handling device, as a means of taking samples of slag or molten metal, of the invention.

FIG. 3 shows a perspective exploded view of the means that make up the sampling system of the invention.

FIG. 4 shows a perspective view of the support grill, for the entire sampling system of the invention.

### DESCRIPTION OF THE INVENTION

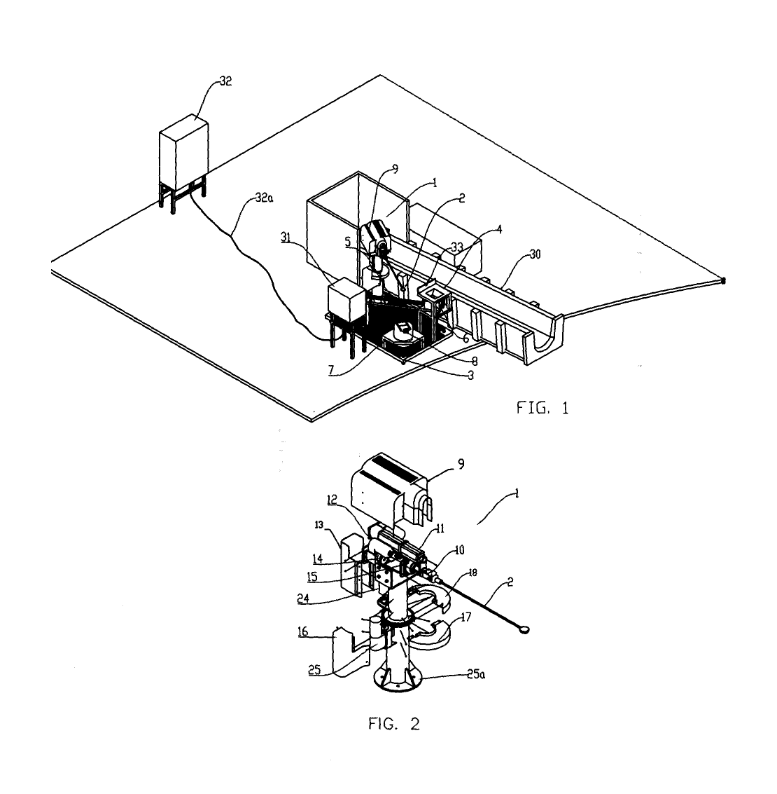

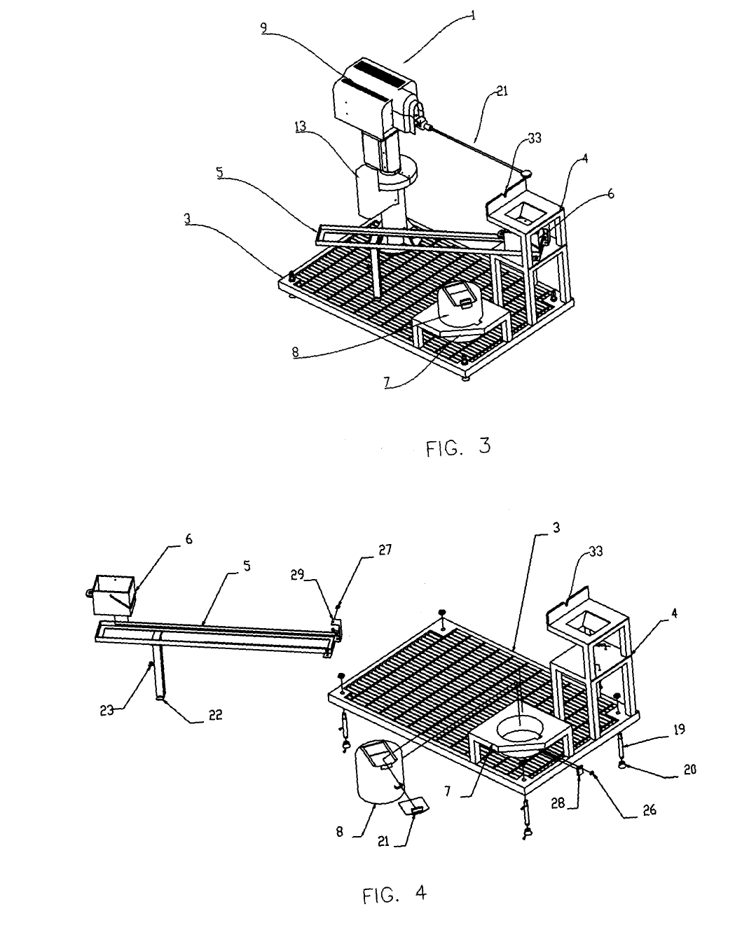

In view of FIGS. 1 to 4, the removable system for the sampling of slag and molten metal for the analysis of minerals

Is made up of a electrical remote mobile handling device (1), equipped with a spoon-type probe (2), as a means to collect dangerous samples from a distance such as slag or liquid molten metal, it also has a base grill (3), as a platform for all areas of the sampling system; a support structure 4) for a rail or guide (5) and a can or bin to take liquid samples of slag or molten metal (6), and a support or platform (7) for a can or bin with a water and lime mixture (8).

The mobile remote handling, device (1) is made up of an upper casing (9), to protect an actuator system (10) from the spoon-type probe (2); a linear electrical actuator (II), which allows to extend the scope of the spoon-type probe (2), a rotating electrical actuator (12), which allows to rotate the probe (2) on its own longitudinal axis, and a spur gear (14) which along with resting (15) allow the probe to rotate on its longitudinal axis while extending; a side casing (13) which protects the electrical linear actuator (24) which in turn at a rotation point allows to incline the probe; and the lower casings (16. 17 y 18) that protect the rotating electrical actuator (25) which provides rotating mobility to the base of the mobile remote handler (1).

The spoon-type probe (2) collects the liquid sample and stores it in the bin (6) which has a spoon-type of configuration and is made of cast iron, which requires cleaning assistance and is made by the mobile remote handler (I). In general term the spoon-type probe (2) will allow its use in practically any point where the liquid material passes or is found, as long as the slag to be sampled is in liquid state and there is proper access so that said spoon-type probe (2) reaches the slag, and that there is sufficient Work space near the Access to the slag where the mobile remote handling device (1) can be installed (1).

The base grill (3) as a platform is equipped with adjustable legs (19) at its four vertices and with bottom caps (20), which allows to manually level said base grill (3) with respect to the ground, in addition all of the means that make up the sampling system of the invention are mounted and supported (remote mobile electrical handling device (1), platform for the bin (4), platform to mix water and lime (7) allowing the sampling system of the invention to be dismantled in few parts and to be re-assembled in another location in little time.

Another function of the base grill (3), is setting a distance between the system mean. This way the remote mobile electrical handling device (1), must only be calibrated once to establish the position of the platforms with respect to same.

The support structure (4) for the sampling bin (6) and guide rail (5) for said bin, is mad e up of a structure with an upper notch (33) where the body of the spoon-type probe (2) must land to deposit, the sample and clean said spoon-type probe (2) provided by a guide to the mobile remote electrical handling device (1) with respect to the place where the liquid slag sampling bin is located (6), The guide rail (5) is a channel means through which the sampling bin (G) can be inserted and removed manually (G) from its place in its support or platform (7) which allows to prevent the operator from coming too close to the channel (3D) to change the sampling bin (6).

The guide rail (5) for the sampling bin (6), has a support (29) with a mechanical sensor (27) with a type of normal open contact, which will indicate to the main controller that, the sampling bin (6) is at the end of the guide rail (5), ready to receive the sample of slag or melted material.

The support or platform (7) is equipped with a support (28) with a mechanical sensor (26) and a type of normal open contact, which will indicate to a main controller that the water and lime mixture bin (8) is located over said support or platform (7).

The support platform (7) and the bin or can (8) used for the water and lime mixture similar to the case of the bin (6), the use of a water and lime bath for the spoon type probe (2) during the process has not been seen altered, but said bin or can (8) shows a closed body with the exception of an opening (34) at the side that points toward the remote handling device (1) through which the spoon type probe will enter (2) for its lime bath; it also shows a slide-type of upper cover (21) to fill the bin or can (8) with the water and lime mixture manually, which allows for the safety of the operator who is located near said remote handling device (I), if the cleaning process of the spoon type probe (2) was not completely successful and there is slag leftover and stuck to the probe. In this case, if the high temperature slag comes in contact with the mixture, there is the possibility that a violent reaction can occur and shoot fragments of slag in all directions. For these rare cases, the design of the new container must be able to contain the material inside itself, eliminating the danger from the operation.

To reduce the quantity of components or means used in the sampling system, the mobile remote electronic handling handled with electrical power. Control and distribution of power is made from the power source (200 VAC and 16 [A] app.) which is mainly located in cabinets, a main medium one (32) and a second smaller one (31), and distribution located in the remote handling device (1) (not illustrated).

The main cabinet (32) takes the power from the plant and energizes the power sources that distribute the voltage to the different system components. This cabinet holds a main controller for the system, which takes the signals from the operator through a control button panel, interprets the signals from the sensors and generates signals to move the handler according to the programmed routine. This main medium cabinet (32) is installed some meters away from the mobile remote electrical handling device (i), to protect the main controller and to maintain the operator (30) away from the channel where the slag passes.

The second cabinet (31) receives control signals and supply from the first main medium cabinet (32). This is where the secondary controllers are found, which are responsible for conditioning the control signal coming from the first cabinet to the modulated signal which will move the actuators that make up the remote mobile electrical handling system (1). It also acts as a pull box for the signals coming from the sensors (not illustrated) toward the main controller. This cabinet is found near the remote sample handling device (1), to prevent the span of the signal modulated toward the actuators to be too long and to reduce the size of the first cabinet if possible while thinking of the complete modularity of the system.

Finally, the distribution boxes (not illustrated) found in the remote mobile electrical handling device (1) have the function of facilitating the disconnection of the system with respect to the small cabinet (31) when the system must be disassembled to be moved to another point.

Last, but not least, the connection between cabinets (31) and (32) is made through rapid connectors, connected at the ends of the cords (32a) that come out of these cabinets (31) and (32). This way, when disassembling the sampling system to move it to another point, it is not necessary to disconnect and reconnect the points individually, it will only have to be have the connectors unplugged and plugged in again, saving time and lowering margins of error in the procedure.

1. System for the sampling of liquid slag, molten metal or similar, to analyze quality and mineral content, deriving partly from the processes used to obtain minerals, said system, allows to improve working conditions and the quality of life of operators and obtain proper sized samples and without risk, CHARACTERIZED because the system used of sample liquid slag is made up of a remote mobile electrical handling device (I), equipped with a spoon type probe (2), as a means to collect dangerous samples from a distance such as liquid slag or molten metal; and also has a base grill (3), as a platform for all areas of the sampling system; a support structure (4) for a rail (5) and a can or bin for the sampling of liquid slag or molten metal (6), and a support or platform (7), for a can or bin with a water and lime mixture (8).

2. System for the sampling of liquid slag, according to claim 1, CHARACTERIZED because the remote mobile handling device (1) is made up of an upper casing (9), to protect an actuator system (10) of the spoon type probe (2), a linear electrical actuator (II), which allows to extend the scope of the spoon type probe (2), a rotating electrical actuator (12), that allows to rotate the probe (2) on nits own longitudinal axis, and a spur gear (14) which along with resting (15) allow the probe to rotate its longitudinal axis as it extends; a side casing (13) that protects the linear electrical actuator (24), which in turn, at a point of rotation allows to slope the probe; and the lower casings (16. 17 and 18) that protect the electrical rotating actuator (25) which provides rotating mobility to the base of the mobile remote handler (1).

3. System for the sampling of liquid slag, according to claim 1, CHARACTERIZED because the probe (2) collects the liquid sample and deposits it in the bin (6) which has a spoon type of configuration manufactured in cast iron, which requires cleaning assistance, which is done by the mobile remote electrical handling device (1).

4. System for the sampling of liquid slag, according to claim 1, CHARACTERIZED because the base grill platform means, is equipped with adjustable legs (19) at its four vertices, bottom caps (20), which allow to manually level said base grill (3) to the ground; in addition, they are mounted a support all of the means that make up the sampling system of the invention (remote mobile electrical handling device (I), bin platform (4), platform for the water and lime mixture (7) allowing the sampling system of the invention to disassemble it in few parts and reassemble it in another location in little time; another function of the base grill (3) is setting a distance among the system means. This way, the remote mobile electrical handling device (1), only needs to be calibrated once to establish the position of the platforms relating to same.

5. System for the sampling of liquid slag, according to claim 1, CHARACTERIZED because the support (7) of the bin (6) is equipped with a support (28) with a mechanical sensor (26) with a type of open normal contact, which will indicate that the bin or water and lime mixture is positioned over the support (7).

6. System for the sampling of liquid slag, according to claim 1, CHARACTERIZED because the support structure (4), for the sampling bin (6) and guide rail (5), is made up of a structure with an upper notch (33), where the spoon type probe body (2) must drop to deposit the simple and then clean with said notch (33), provided by a guide to the remote mobile electrical handling device (1) with respect to where the sampling bin (B) of liquid slag is located.

7. System for the sampling of liquid slag, according to claims 1 and 6 CHARACTERIZED because the rail or guide (5) is a channel through which the sampling bin (6) can be manually inserted and removed (6) from its position on its platform, which allows to prevent the operator from getting too close to the channel (3D) to replace the bin; in addition, said rail or guide (5) has a support (29) for a mechanical sensor (27) type of normal open contact, which will indicate the location of the sampling bin (6) and which is located at the end of the guide rail (5) ready to receive the sample of slag or melted material.

8. System for the sampling of liquid slag, according to claim 1, CHARACTERIZED because said bin or can (8) has a closed body with the exception of one opening (34) at the side that points to the remote handling device (1), through which will enter the spoon type probe (2), for its lime bath; and also has a type of sliding top lid (21) to fill the bin or can (8) with the water and lime mixture manually, which provides safety to the operator that is near the remote handling device (I) in case the cleaning process of the spoon type probe (2) is not completely successful and there remaining red slag adhered, to the probe; in this case, if the high temperature slag comes in contact with the mixture, there is the possibility that a violent reaction can occur throwing fragments of slag in all directions.

9. System for liquid slag, according to claim 1, CHARACTERIZED because to reduce the quantity of components or means used the sampling system, the remote mobile electrical handling device (1) is operated with electrical power; the control and distribution of the power from a power source (220 VAC and 16 [A] app.) is mainly found in some cabinets, a main medium one (32) and a second smaller one (31) and distribution boxes found in the remote handling device (1).

10. System for the sampling slag, according to claims 1 and 9, CHARACTERIZED because the main medium cabinet (32) takes the power from the plant and energizes the power sources which distribute the voltages that correspond to the different system components, in the medium cabinet (32) there is a main controller for the system, that takes the signals from the operator through a button control panel, and interprets the signals from the sensors and generates the signals to move the handler according to the programmed routine; said main medium cabinet (32) is installed some meters away from the remote mobile electrical handling device (1), to protect the main controller and keep the channel opera or (30) away from where the slag passes.

11. System for the sampling of liquid slag, according to claims 1, 9 and 10. CHARACTERIZED because the second smaller cabinet (31), receives the control signals and supply from the first main medium cabinet (32), where there are secondary controllers responsible for conditioning the control signal coming from the first cabinet (31) to the modulated signal which will move the actuators that make up the remote mobile electrical handling device (1); it also acts as a junction box for the signals coming from the sensors to the main controller; the cabinet (31) is located near the remote sample handling device (1), to avoid that the section of the signal modulated toward the actuators is too long and to reduce as much as possible the size of the main medium cabinet (32) thinking of the complete modularity of the system.

12. System for the sampling of liquid slag, according to claim 9, CHARACTERIZED because the distribution boxes mounted on the remote mobile electrical handling device (1) have a function bed to facilitate disconnecting the system with respect to the small cabinet (31) when the system is to be disassembled to be moved to another point.

13. System for the sampling of liquid slag, according to claims 10, 11 and 12, CHARACTERIZED because the connection between the cabinets (31) and (32) is made through rapid connectors connected at the ends of the cords (32a) that come out of said cabinets (31) and (32); this way, when disassembling the sampling system to move it to another location, it is not necessary to disconnect it and reconnect, the points individually, it will only have to be unplugged and then plug the connectors again, saving time and decreasing the error points in the procedure.
